(19) United States
(12) Patent Application Publication
(10) Pub. No.: US 2007/0181855 A1
(43) Pub. Date: Aug. 9, 2007

(54) Carbon-based electrically conducting filler, composition and use thereof

(76) Inventors: Yuji Nagao, Kanagawa (JP); Ryuji Yamamoto, Kanagawa (JP)

Correspondence Address: SUGHRUE MION, PLLC, 2100 PENNSYLVANIA AVENUE, N.W., SUITE 800, WASHINGTON, DC, 20037, US

(21) Appl. No.: 10/591,122

(22) PCT Filed: Apr. 14, 2005
(86) PCT No.: PCT/JP05/07572

§ 371 Date: Aug. 30, 2006

Related U.S. Application Data
(60) Provisional application No. 60/564,969, filed on Apr. 26, 2004.
(60) Provisional application No. 60/564,972, filed on Apr. 26, 2004.
(60) Provisional application No. 60/564,974, filed on Apr. 26, 2004.
(60) Provisional application No. 60/605,508, filed on Aug. 31, 2004.

(30) Foreign Application Priority Data
Apr. 15, 2004 (JP) 2004-120429
Apr. 15, 2004 (JP) 2004-120430
Apr. 15, 2004 (JP) 2004-120431
Aug. 24, 2004 (JP) 2004-243740

(51) Int. Cl. H01B 1/12

(52) U.S. Cl. 252/500

(57) ABSTRACT

A conductive composition comprising a vapor grown carbon fiber having an aspect ratio of 40 to 1,000, preferably 65 to 1,000, and a specific surface area or fiber diameter of the fiber within a predetermined range, and a preferable peak intensity ratio (I₀=I₁₃₆₀/I₁₅₈₀) of 0.1 to 1, wherein I₁₅₈₀ represents a peak height at 1,580 cm⁻¹ and I₁₃₆₀ represents a peak height at 1,360 cm⁻¹ in a Raman scattering spectrum; and a resin composition containing the composition; and a production method thereof. The present invention provides: i) a composition which exhibits stable conductivity and less deterioration in physical properties during any molding methods in a conductive plastic in which a conductive filler is dispersed in a polymer; ii) a composite material composition for precision molding which enables production of a molded product with low warpage and is excellent in mechanical properties and performance during the injection molding; and iii) a sliding member composition which exhibits durability under high temperature and heavy load and has a low friction coefficient.

### CROSS REFERENCE TO THE RELATED APPLICATIONS

This is an application filed pursuant to 35 U.S.C. Section 111(a) with claiming the benefit of U.S. Provisional application Ser. No. 60/564,969 filed Apr. 26, 2004, U.S. Pat. No. 60/564,972 filed Apr. 26, 2004, U.S. Pat. No. 60/564,974 filed Apr. 26, 2004 and U.S. Pat. No. 60/605,508 filed Aug. 31, 2004 under the provision of 35 U.S.C. Section 111(b), pursuant to 35 U.S.C. Section 119(e) (1).

### TECHNICAL FIELD

The present invention relates to a carbon-based conductive filler, a composition and use thereof. More particularly, the invention relates to a carbon-based conductive filler which can easily be dispersed in a matrix resin, thereby readily forming a conductive network in the resin, a conductive composition containing the filler and use thereof.

### BACKGROUND ART

Conventionally, properties such as conductivity and antistatic characteristics have long been imparted to a thermoplastic resin, which is an electrically insulating material, through incorporation of a conductive filler into the resin, and a variety of conductive fillers have been employed for this purpose. Examples of generally employed conductive fillers include carbon-based materials having a graphite structure such as carbon black, graphite, vapor grown carbon fiber and carbon fiber; metallic materials such as metallic fibers, metallic powders and metallic foil; metallic oxides; and metal-coated inorganic fillers.

Among these conductive fillers, attempts have been made to utilize carbon-based conductive filler, since it is considered to exhibit excellent conductivity as well as satisfactory stability against atmospheric conditions (e.g., corrosion resistance), resistance to electric disorders caused by metallic powder, sliding characteristics (e.g., less wear of screws of a molding apparatus during molding), etc. The carbon-based conductive filler tends to be used in a wider variety of fields. In particular, in order to attain high conductivity through incorporation of a small amount of conductive filler, size reduction, increase in aspect ratio and specific surface area and other modification of conductive fillers have been found to be effective. Thus, methods have been employed such as reducing the fiber diameter or increasing the specific surface area of fibrous fillers (for example, Japanese Patent No. 2641712 (U.S. Pat. No. 4,663,230)), or utilizing carbon black and hollow carbon fibrils (carbon nanotubes) having a remarkably large specific surface area.

However, carbon black and carbon nanotubes (diameter: about 1 to 40 nm) have a remarkably large specific surface area (specific surface area: 800 m²/g (carbon black) and 250 m²/g (carbon nanotubes)). In other words, carbon black and carbon nanotubes have a large aggregation energy per unit mass, and therefore, when these materials are incorporated into resin, aggregation power in molten resin increases, requiring high shear force for uniformly dispersing the carbon materials in the molten resin. During dispersion, carbon nanotubes may be broken and aggregation of carbon filaments may occur. Thus, when such carbon materials are employed, stable conductivity is very difficult to attain.

Meanwhile, Japanese Laid-Open Patent Publication (kokai) No. 2-298554 discloses a resin composition for a conductive sliding member, which composition is formed of a resin composition containing 1 to 80 mass % of a graphitized vapor grown carbon fiber having a fiber diameter of 0.01 to 5 μm. However, the publication claims a considerably wide scope of resin composition, and some examples are unreproducible, leaving questions of credibility to the disclosure.

Japanese Laid-Open Patent Publication No. 64-65144 discloses use of a vapor grown carbon fiber as a conductive filler, which fiber has a fiber diameter of 0.05 to 2 μm, a length of 10 μm or less and a specific surface area of 10 to 500 m²/g. Since the carbon fiber has a mean fiber length less than 10 μm, excellent dispersibility in resin is attained, but the filler must be added in an increased amount so as to form a conductive network.

Conventionally, a carbon fiber (hereinafter may be referred to as “CF”)-reinforced composite material for injection molding has employed, as a filler, PAN-based CF or pitch-based CF, which is cut into a size of a few millimeters or pulverized into a size of 1 mm or less. However, a resin composite material employing PAN-based CF or pitch-based CF involves problems that the filler tends to be oriented in the direction of flow of the resin during the injection molding of the composite material, and therefore molding shrinkage and mechanical properties in the flow direction tend to differ from those in the direction perpendicular to the flow direction. In addition, such a resin composite material poses problems that anisotropy in alignment of the filler causes warpage of a product produced by molding the resin composite material (see FIG. 2), or causes unsatisfactory dimensional accuracy of the molded product. Particularly, in precision molded parts requiring high dimensional accuracy, anisotropy in alignment of a filler employed in the resin is detrimental.

In order to solve such problems, there has been proposed a technique employing, as a filler, whiskers of a ceramic material such as potassium titanate (see Japanese Laid-Open Patent Publication No. 8-157718).

However, needless to say, such whiskers fail to impart satisfactory electrical conductivity to resin. Furthermore, the resultant composite material fails to exhibit satisfactory physical properties and sufficient isotropy in physical properties, although the isotropy is improved as compared with the case of a composite material employing PAN-based CF and the like.

When electrically conductive carbon black is employed as a filler in a composite material, the resultant composite material exhibits relatively good isotropy in electrical conductivity and mechanical properties (e.g., bending strength), but the composite material is totally unsatisfactory in reinforcing mechanical properties.

Also, there has been disclosed a technique employing vapor grown carbon fiber as an electrically conductive filler (Japanese Laid-Open Patent Publication No. 4-45157). When vapor grown carbon fiber having a low aspect ratio (e.g., an aspect ratio of less than 40) is employed in a composite material, the carbon fiber is effective in reducing warpage to produce a molded product with low warpage. However, the composite material exhibits a thermal conductivity of 1 W/mK or less, and thus high cycle molding cannot be performed at a high mold temperature. Meanwhile, the higher the aspect ratio of vapor grown carbon fiber, the easier the carbon fiber is oriented in a composite material. Therefore, the composite material containing high-aspect-ratio carbon fiber exhibits low thermal conductivity, and cycle performance of the composite material is deteriorated when a high-temperature mold is employed. Currently, a composite material employing vapor grown carbon fiber having a high aspect ratio fails to achieve satisfactory results.

Plastic sliding members have come to be widely used in mechanism parts employed in the electrical and electronic industries and in the automobile industry, and have attracted attention for potential uses. Though a plastic material has self-lubricating property that is required for a sliding member, it exhibits a low PV limit value and low thermal conductivity as compared with a metallic material,. The term “PV limit value” refers to a limit value of a load indicated by a product of “P” and “V”, where fusion or burnout of the sliding member occurs when a peripheral velocity V (cm/sec) of the member exceeds a specific value at a certain load P (kg/cm²). Therefore, heat accumulation in the plastic material cannot be prevented, resulting in poor mechanical properties (e.g., rigidity) . In order to employ a plastic material as a sliding member such as a bearing, the plastic material desirably has satisfactory dynamic properties (e.g., strength and rigidity), low kinetic friction coefficient, high wear resistance, high PV limit value, and sliding characteristics (i.e., capability to prevent damage to a sliding counter material).

A resin composite material employing carbon fiber for the purpose of improving dynamic properties of the composite material has been widely used in a variety of industries including the aerospace industry and the automobile industry, in sporting goods and in industrial materials. Carbon fiber employed as a filler in such a resin composite material is generally produced by baking acrylic fiber or pitch-based fiber. A composite material containing such carbon fiber exhibits excellent dynamic properties and heat resistance, but has unsatisfactory wear resistance. Therefore, when such a composite material is employed as a sliding member for a variety of industrial purposes, the sliding member has a shortened service life, and has not always achieved the desired results in practical use. Steel, which is generally employed as a counter material of a sliding member, is likely to be replaced by a lightweight material such as aluminum. A carbon-fiber-containing composite sliding member causes damage not only to a soft aluminum material but also to hard steel. Thus, such carbon fiber is not suitable for use in a sliding member.

There has been proposed a sliding member which is obtained by mixing a synthetic resin with vapor grown carbon fiber or vapor grown carbon fiber which has been graphitized through thermal treatment (see, for example, Japanese Laid-Open Patent Publication No. 3-38327). However, in this sliding member, merely wear resistance is improved, and load resistance and heat resistance, which are required for the aforementioned sliding member, are insufficiently improved.

Also, there has been proposed a sliding member which is obtained by dispersing vapor grown carbon fiber (or vapor grown carbon fiber which has been graphitized through thermal treatment) with fine molybdenum disulfide powder in a synthetic resin (see, for example, Japanese Laid-Open Patent Publication No. 4-11693). However, since this sliding member contains a synthetic resin, the member is not suitable for use at high temperature, in the presence of a corrosive fluid, or under application of high load. In addition, since this sliding member contains molybdenum disulfide, oxidation of molybdenum may occur under oxygen-rich conditions, leading to an increase in the friction coefficient of the member.

Meanwhile, there has been proposed a bearing material which employs a sliding member obtained by mixing polyamide resin or polyimide resin, which serves as a matrix, with vapor grown carbon fiber, molybdenum disulfide, graphite, PTFE or the like; and enables to reduce wear without increasing friction coefficient (see, for example, Japanese Laid-Open Patent Publication No. 5-59387). However, similar to the case of the above-described sliding member, limitations are imposed on the use of this sliding member.

Also, there has been proposed a sliding member having a multi-layer structure comprising a surface layer formed of a composite material containing carbon nanotube exhibiting good slidability, and an inner layer formed of a heat-resistant material (see Japanese Laid-Open Patent Publication No. 2003-239977). Although this sliding member exhibits satisfactory performance, the sliding member involves problems in terms of, for example, cost, since the member employs expensive carbon nanotube and requires a very cumbersome production process.

### DISCLOSURE OF THE INVENTION

In view of the foregoing, an object of the present invention is to form a stable conductive network through addition of a very small amount of a conductive filler, and more specifically, to provide a conductive plastic in which a conductive filler is dispersed in a polymer; inter alia, a plastic product which contains a conductive filler in an amount equivalent to the conventional amount and yet exhibits higher conductivity or a plastic product which contains a smaller amount of a conductive filler and yet exhibits conductivity equivalent to or higher than the conventionally attained conductivity, and a composition which exhibits stable conductivity and less deterioration in physical properties during any molding methods.

Another object of the present invention is to provide a composite material composition which enables production of a molded product with low warpage, which exhibits isotropy in mechanical properties, which exhibits excellent dynamic properties (e.g., strength and elastic modulus), electrical conductivity, thermal conductivity, sliding characteristics and surface smoothness, and which exhibits excellent cycle performance during the course of injection molding.

Still another object of the present invention is to provide a sliding member composition and a production method thereof, which composition exhibits durability under high temperature and heavy load; has a low friction coefficient (high wear resistance); rapidly releases generated heat by virtue of high thermal conductivity; inflicts no damage on the counter member even when the counter member is made of aluminum; and maintains its performance for a long period of time.

The present inventors have conducted extensive studies on the specific surface area and aspect ratio of vapor grown carbon fiber in order to form a stable conductive network through addition of a very small amount of a vapor grown carbon fiber, and have found a vapor grown carbon fiber which can be uniformly dispersed in a molten resin under low shear force causing no breakage of the carbon fiber.

The present inventors have also found that by incorporating a specific vapor grown carbon fiber into a composite material composition while suppressing breakage of the carbon fiber to a minimum possible level, and by injection-molding the composition in a low melt viscosity, alignment of the vapor grown carbon fiber contained in the thus-molded product is impeded, whereby the composite material composition can be endowed with such an excellent performance which has not conventionally been attained.

Further, the present inventors have found that by incorporating a specific vapor grown carbon fiber into a composite material composition and by suppressing breakage of the carbon fiber during incorporation to a minimum possible level, the composite material composition exhibits a performance which has not conventionally been attained.

The present invention has been accomplished on the basis of these findings.

Accordingly, the present invention provides a conductive filler, a conductive resin composition containing the filler, a production method and use of the composition as follows.

1. A conductive filler for a conductive resin, characterized by comprising a vapor grown carbon fiber having a specific surface area of 10 to 50 m²/g and an aspect ratio of 65 to 1,000.

2. The conductive filler for a conductive resin as described in 1 above, characterized by comprising a vapor grown carbon fiber having a specific surface area of 15 to 40 m²/g and an aspect ratio of 110 to 200.

3. The conductive filler as described in 1 or 2 above, wherein the vapor grown carbon fiber has a fiber diameter of 50 to 200 nm, a mean fiber length of 10 μm or more, and a peak intensity ratio (I₀=I¹³⁶⁰/I₁₅₈₀) of 0.1 to 1, wherein I₁₅₈₀ represents a peak height at 1,580 cm⁻¹ and I₁₃₆₀ represents a peak height at 1,360 cm⁻¹ in a Raman scattering spectrum.

4. A conductive resin composition comprising the conductive filler as described in any of 1 to 3 above in a matrix resin, which composition contains the conductive filler in an amount of 1 to 70 mass %.

5. The conductive resin composite composition as described in 4 above, wherein the matrix resin is at least one species selected from thermoplastic resin and thermosetting resin.

6. A method for producing the conductive resin composition as described in 4 or 5 above, comprising melt-mixing a conductive filler composed of vapor grown carbon fiber into a matrix resin, characterized in that breakage rate of the vapor grown carbon fiber during melt-mixing is suppressed to 20% or less.

7. The method for producing a conductive resin composition as described in 6 above, further comprising monitoring the mixture under an electron microscope, so that the melt-mixing is performed without generating an aggregated mass of vapor grown carbon fiber.

8. The method for producing a conductive resin composition as described in 6 or 7 above, wherein melt-mixing is performed by means of a twin-screw extruder (same rotation direction) or a pressure kneader.

9. A synthetic resin molded article comprising the conductive resin composition as described in 4 or 5 above.

10. A container for electric and electronic parts comprising the conductive resin composition as described in 4 or 5 above.

11. A conductive sliding member comprising the conductive resin composition as described in 4 or 5 above.

12. A conductive thermal-conducting member comprising the conductive resin composition as described in 4 or 5 above.

13. A composite material composition produced by kneading a matrix synthetic resin and a vapor grown carbon fiber, wherein the vapor grown carbon fiber has a fiber diameter of 50 to 200 nm, an aspect ratio of 40 to 1,000, and a peak intensity ratio (I₀=I₁₃₆₀/I₁₅₈₀) of 0.1 to 1, wherein I₁₅₈₀ represents a peak height at 1,580 cm⁻¹ and I₁₃₆₀ represents a peak height at 1,360 cm⁻¹ in a Raman scattering spectrum, and the composition exhibits an anisotropic ratio in mold shrinkage factor of 0.5 or more.

14. The composite material composition as described in 13 above, wherein the composition is produced by incorporating a vapor grown carbon fiber having a bulk density of 0.01 to 0.1, while a breakage rate of the carbon fiber is controlled to 20% or less.

15. The composite material composition as described in 13 or 14 above, wherein the synthetic resin is a thermoplastic resin.

16. The composite material composition as described in any of 13 to 15 above, which exhibits a thermal conductivity of 1 W/mK or higher.

17. A method for producing a composite material composition characterized by comprising kneading a thermoplastic resin and a vapor grown carbon fiber having a fiber diameter of 50 to 200 nm, an aspect ratio of 40 to 1,000, a bulk density of 0.01 to 0.1 and a peak intensity ratio (I₀=I₁₃₆₀/I₁₅₈₀) of 0.1 to 1, wherein I₁₅₈₀ represents a peak height at 1,580 cm⁻¹ and I₁₃₆₀ represents a peak height at 1,360 cm⁻¹ in a Raman scattering spectrum, wherein the kneading is performed without applying strong shear force, so as to suppress breakage rate of the carbon fiber to 20% or less.

18. The method for producing a composite material composition as described in 17 above, wherein the vapor grown carbon fiber is incorporated into a composite material composition in an amount of 10 mass % to 70 mass % during kneading of the thermoplastic resin and the vapor grown carbon fiber.

19. The method for producing a composite material composition as described in 17 or 18 above, wherein the thermoplastic resin and the vapor grown carbon fiber are kneaded while breakage rate of the carbon fiber is suppressed to 20% or less, by melt-kneading using a pressure kneader and subsequent pelletizing using a single-screw extruder or a reciprocating-single-screw extruder.

20. A method for producing a composite material molded article, characterized by comprising molding a composite material composition produced by the method for producing a composite material composition as described in any of 17 to 19 above, at a mold temperature 20° C. to 40° C. higher than such an injection molding temperature that the time required for cooling the mold is five seconds and a non-defective production rate of 95% or higher is attained.

21. A precision-molding synthetic resin molded article, which employs a resin composition produced through a method for producing a precision-molding composite material composition as described in any of 17 to 19 above.

22. A container for electric and electronic parts, which employs a resin composition produced through a method for producing a precision-molding composite material composition as described in any of 17 to 19 above.

23. A sliding member composition produced by kneading a matrix synthetic resin and a vapor grown carbon fiber, wherein the vapor grown carbon fiber has a fiber diameter of 50 to 200 nm, an aspect ratio of 40 to 1,000, and a peak intensity ratio (I₀=I₁₃₆₀/I₁₅₈₀) of 0.1 to 1, wherein I₁₅₈₀ represents a peak height at 1,580 cm⁻¹ and I₁₃₆₀ represents a peak height at 1,360 cm⁻¹ in a Raman scattering spectrum, and the composition exhibits a heat deflection temperature of 160° C. or higher under heavy load, as determined in accordance with ASTM D 648.

24. The sliding member composition as described in 23 above, which contains the vapor grown carbon fiber in an amount of 10 mass % to 70 mass %.

25. The sliding member composition as described in 23 or 24 above, which exhibits a thermal conductivity of 1 W/mK or higher.

26. The sliding member composition as described in any of 23 to 25 above, which exhibits a flexural modulus of 4,000 MPa or more.

27. A method for producing a sliding member composition characterized by comprising kneading a thermoplastic resin and a vapor grown carbon fiber having a fiber diameter of 50 to 200 nm, an aspect ratio of 40 to 1,000, a bulk density of 0.01 to 0.1, and a peak intensity ratio (I₀=I₁₃₆₀/I₁₅₈₀) of 0.1 to 1, wherein I₁₅₈₀ represents a peak height at 1,580 cm⁻¹ and I₁₃₆₀ represents a peak height at 1,360 cm⁻¹ in a Raman scattering spectrum, wherein the kneading is performed without applying strong shear force so as to suppress breakage rate of the carbon fiber to 20% or less.

28. The method for producing a sliding member composition as described in 27 above, wherein the vapor grown carbon fiber is incorporated into a composite material composition in an amount of 10 mass % to 70 mass % during kneading of the thermoplastic resin and the vapor grown carbon fiber.

29. The method for producing a sliding member composition as described in 27 or 28 above, wherein the thermoplastic resin and the vapor grown carbon fiber are kneaded while breakage rate of the carbon fiber is suppressed to 20% or less, by melt-kneading using a pressure kneader and subsequent pelletizing using a single-screw extruder or a reciprocating-single-screw extruder.

30. The method for producing a molded sliding member, characterized by comprising molding a sliding member composition produced by the method for producing a sliding member composition as described in any of 27 to 29 above, at a mold temperature 20° C. to 40° C. higher than such an injection molding temperature that the time required for cooling the mold is five seconds and a non-defective production rate of 95% or higher is attained.

31. A sliding synthetic-resin molded article, which employs a resin composition produced by the method for producing a sliding member composition as described in any of 27 to 29 above.

32. A non-lubricant sliding member, which employs a resin composition produced by the method for producing a sliding member composition as described in any of 27 to 29 above.

### BRIEF DESCRIPTION OF THE DRAWINGS

FIG. 1 is an electron microscopic photograph of a conductive resin composition according to the present invention (Example 3).

FIG. 2 is a graph indicating the relationship between mold shrinkage factor (machine direction/transverse direction) and the amount of vapor grown carbon fiber or carbon fiber

FIG. 3 is a graph indicating the dependence of kinetic friction coefficient on vapor grown carbon fiber content.

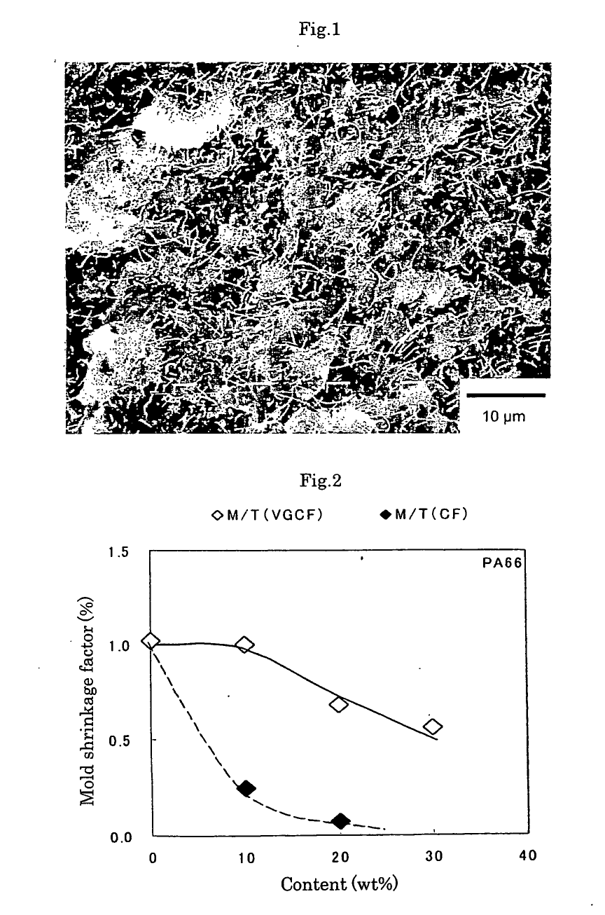

### BEST MODE FOR CARRYING OUT THE INVENTION

As a first objective, the present invention provides a conductive filler which can easily be dispersed in a matrix resin, thereby readily forming a conductive network in the resin and provides a conductive composition containing the filler and use thereof.

Since carbon nanotubes have a large aggregation energy, high shear force is required to knead resin with carbon nanotubes. Thus, during dispersion, carbon nanotubes may be broken and aggregation of carbon filaments may occur, which makes it difficult to attain stable conductivity. In contrast, according to the present invention, a vapor grown carbon fiber adjusted to have a specific surface area and aspect ratio is employed. Such carbon fiber can be uniformly dispersed in molten resin under low shear force which causes no breakage of carbon fiber, and a stable conductive network can be formed through addition of a small amount of conductive filler. Thus, the invention is highly valuable in the industrial field.

The conductive resin composition according to the present invention prevents release of carbon microparticles from molded articles, maintains impact characteristics of resin per se, and attains not only high conductivity but also excellent sliding characteristics, high thermal conductivity, high strength, high elastic modulus, high flowability during molding and high surface flatness of molded articles.

Molded articles made of the conductive resin composition are excellent in terms of mechanical strength, easiness of coating, thermal stability and impact tenacity as well as conductivity and antistatic performance. Thus, such articles can be advantageously used in a variety of fields such as transportation of electric/electronic parts, parts for packaging, parts used in the electric/electronic industry, parts for OA apparatuses, conductive sliding members, conductive thermal-conducting members, and automobile parts to be coated with static coating.

The vapor grown carbon fiber employed in the present invention for this purpose has a specific surface area of 10 to 50 m²/g, preferably 15 to 40 m²/g. When the specific surface area falls within the range, the vapor grown carbon fiber can be readily dispersed in a matrix resin, whereby a conductive network can be readily formed in the resin.

The vapor grown carbon fiber employed in the present invention preferably has the following physical properties.
Aspect ratio: 65 to 1,000, preferably 65 to 800, more preferably 80 to 500, particularly preferably 110 to 200. In general, impact tenacity increases as increase in aspect ratio. However, when the aspect ratio exceeds 1,000, fiber filaments are entangled with one another, thereby in some cases causing decrease in conductivity, flowability during molding, and impact tenacity, whereas when the aspect ratio is less than 65, the resin to which the vapor grown carbon fiber is added exhibits poor conductivity.
Fiber diameter: 50 to 200 nm, preferably 70 to 200 nm, particularly preferably 70 to 140 nm.
Mean fiber length: 10 μm or more, preferably 10 to 100 μm, particularly preferably 12 to 50 μm.
Peak intensity (at 1,580 cm⁻¹ and 1,360 C⁻¹ in Raman scattering spectrum) ratio (I₀=I₁₃₆₀/I₁₅₈₀) : 0.1 to 1, preferably 0.1 to 0.8. A graphitized (highly crystallized) vapor grown carbon fiber exhibits a peak intensity ratio of about 0.1, while non-graphitized carbon exhibits a peak intensity ratio of about 2.0.

The vapor grown carbon fiber employed in the present invention may be produced by, for example, feeding a gasified organic compound with iron serving as a catalyst into an inert gas atmosphere at high-temperature (see, for example, Japanese Patent Application Laid-Open (kokai) No. 7-150419).

The thus-produced vapor grown carbon fiber may be used without performing any further treatment. Alternatively, the produced vapor grown carbon fiber subjected to heat treatment at 800 to 1,500° C. or graphitizing treatment at 2,000 to 3,000° C. may be employed.

No particular limitation is imposed on the polymer (matrix resin) employed in the present invention, and either thermosetting resin or thermoplastic resin can be employed, and the matrix resin preferably exhibits low viscosity during molding. Examples of preferred resins include engineering plastics, super-engineering plastics, low-molecular-weight plastics and thermosetting resins. High-molecular weight plastics are also preferably employed, so long as molding can be performed at higher temperature for reducing viscosity.

No particular limitation is imposed on the thermoplastic resin, and any moldable thermoplastic resins can be employed. Examples include polyesters such as polyethylene terephthalate (PET), polybutylene terephthalate (PBT), polytrimethylene terephthalate (PTT), polyethylene naphthalate (PEN), and liquid crystal polyester (LCP); polyolefins such as polyethylene (PE), polypropylene (PP), polybutene-1 (PB-1), and polybutylene; styrene resins; polyoxymethylene (POM); polyamides (PA); polycarbonates (PC); poly(methyl methacrylate) (PMMA); poly(vinyl chloride) (PVC); polyphenylene ether (PPE); polyphenylene sulfide (PPS); polyimides (PI); polyamide-imides (PAI); polyether-imides (PEI); polysulfones (PSU); polyether-sulfones; polyketones (PK); polyether-ketones (PEK); polyether-ether-ketones (PEEK); polyether-ketone-ketones (PEKK); polyarylates (PAR); polyether-nitriles (PEN); phenol (e.g., novolak) phenoxy resins; and fluorine-containing resins such as polytetrafluoroethylene (PTFE) . Examples further includes thermoplastic elastomers such as polystyrene-, polyolefin-, polyurethane-, polyester-, polyamide-, polybutadiene-, polyisoprene-, or fluorine-containing elastomers; copolymers thereof; modified products thereof; and combinations of two or more species thereof.

In order to enhance impact resistance, other elastomer or rubber components may be added to the aforementioned thermoplastic resins. Examples of the elastomers include olefin elastomers such as EPR and EPDM, styrene elastomer such as SBR comprising styrene-butadiene copolymer, silicone elastomer, nitrile elastomer, butadiene elastomer, urethane elastomer, nylon elastomer, ester elastomer, fluororesin elastomer, natural rubber, and modified product thereof to which a reactive site (e.g., double bond, carboxylic acid anhydride moiety) is introduced.

No particular limitation is imposed on the thermosetting resin, and any resin used in molding can be employed. Examples include unsaturated polyester resins, vinyl ester resins, epoxy resins, phenol (resol) resins, urea-melamine resins and polyimide resins; copolymers thereof; modified products thereof; and combinations of two or more species thereof. In order to enhance impact resistance, an elastomer or a rubber component may be added to the aforementioned thermosetting resins.

The vapor grown carbon fiber content in the conductive resin composition is 1 to 70 mass %, preferably 3 to 60 mass %, more preferably 3 to 50 mass %, particularly preferably 3 to 20 mass %.

Into the conductive resin composition of the present invention, a variety of other resin additives may be incorporated, so long as the effects or achievement of objectives of the present invention are not affected. Examples of the resin additives which may be incorporated into the composition include a colorant, a plasticizer, a lubricant, a heat stabilizer, a photo-stabilizer, a UV-absorber, a filler, a foaming agent, a flame retardant and an anti-corrosive agent. These resin additives are preferably incorporated at a final stage of preparation of the conductive resin composition of the present invention.

In the present invention, during mixing and kneading components for forming the conductive resin composition, breakage of the vapor grown carbon fiber is preferably suppressed to a minimum possible level. Specifically, the breakage rate of vapor grown carbon fiber is preferably controlled to 20% or less, more preferably 15% or less, particularly preferably 10% or less. The breakage rate may be evaluated through comparison of aspect ratio before and after mixing/kneading (e.g., measured from an electron microscopic (SEM) image).

In order to perform mixing/kneading with suppressing breakage of the vapor grown carbon fiber to a minimum possible level, the following method may be employed.

Generally, when a thermoplastic resin or a thermosetting resin is melt-kneaded with an inorganic filler, high shear force is applied to aggregated inorganic filer filaments, thereby breaking the inorganic filler to form minute fragments, whereby the inorganic filer is uniformly dispersed in a molten resin. In order to generate such high shear force, a variety of kneaders are employed. Examples include a kneader based on a stone mill mechanism and a twin-screw (same rotation direction) extruder having kneading disks in a screw element for applying high shear force. However, when such a type of kneader is employed, vapor grown carbon fiber is broken during the kneading step. If a singe-screw kneader generating weak shear force is employed, breakage of carbon fiber is prevented, but carbon fiber fails to be uniformly dispersed. Therefore, in order to attain uniform dispersion while breakage of fiber is suppressed, it is preferable to reduce shear force by employing a twin-screw extruder (same rotation direction) having no kneading disk, or to employ a pressure kneader which attains dispersion over a long period of time without applying high shear force or a single-screw extruder having a specially designed mixing element.

Upon filling a resin with an inorganic filler, wetting of the inorganic filler with molten resin is also a critical issue, and it is essential to increase the interfacial area between the resin and the inorganic filler. In order to enhance wettability, the surface of vapor grown carbon fiber may be oxidized.

When the vapor grown carbon fiber employed in the present invention has a bulk density of about 0.01 to 0.1 g/cm³, the fiber is not dense and readily entrains air. In this case, degassing fiber is difficult when a conventional single-screw extruder and a twin-screw (same rotation direction) extruder is employed, and thus high-density filling into resin becomes difficult. In this case, a batch-type pressure kneader is preferably employed in order to attain high-density filling while suppressing breakage of the carbon fiber to a minimum possible level. The thus-kneaded product obtained by use of a batch-type pressure kneader may be input to a single-screw extruder before solidification to be pelletized.

When the conductive resin composition of the present invention has a conductive filler content of 20 mass %, the volume resistivity can be adjusted to 10² to 10¹² Ωcm, preferably to 10⁴ to 10¹⁰ Ωcm.

The conductive resin composition of the present invention is suitably employed as a molding material for producing articles which require impact resistance and conductivity or antistatic property; e.g., OA apparatuses, electronic apparatuses, conductive packaging parts, conductive sliding members, conductive thermal-conducting members, antistatic packaging parts, and automobile parts to be coated with static coating. These articles may be produced through any conventionally known molding method of conductive resin compositions. Examples of the molding methods include injection molding, blow molding, extrusion, sheet molding, heat molding, rotational molding, lamination molding and transfer molding.

As a second objective, the present invention provides a composite material composition which enables production of a molded product with low warpage, which exhibits isotropy in mechanical properties, which exhibits excellent dynamic properties (e.g., strength and elastic modulus), electrical conductivity and thermal conductivity, and which exhibits excellent cycle performance (i.e., molding is completed within a short cycle time) particularly during the course of injection molding.

According to the present invention, a vapor grown carbon fiber having a high aspect ratio (≧40) and a thermoplastic resin are melt-kneaded while reduction in aspect ratio is suppressed to a minimum possible level, and alignment of the vapor grown carbon fiber contained in the resin is impeded through injection-molding the composition of a low melt viscosity, thereby attaining excellent cycle performance of the composite material composition. Thus, the present invention provides remarkably high utility in the industry.

The composite material composition according to the present invention exhibiting high cycle performance is excellent in dynamic properties (e.g., strength and elastic modulus), electrical conductivity and thermal conductivity, as well as in precision-moldability (e.g., warpage resistance). Thus, the composite material composition is applicable to complicated parts used in the electrical and electronic industry, in the automobile industry and in other industries.

The vapor grown carbon fiber employed in the present invention for this purpose may be produced by, for example, feeding a gasified organic compound with iron serving as a catalyst into an inert gas atmosphere at high-temperature (see, for example, Japanese Laid-Open Patent Publication No. 4-45157).

The thus-produced vapor grown carbon fiber may be used without performing any further treatment. Alternatively, the produced vapor grown carbon fiber subjected to heat treatment at 800 to 1,500° C. or graphitizing treatment may be employed.

The cross-section of the vapor grown carbon fiber may assume a perfect circle, an ellipse or a polygon. The carbon fiber may contain on its surface a carbonaceous substance deposited through pyrolysis of carbon. After completion of production, the vapor grown carbon fiber may be further treated at 2,000° C. or higher in order to enhance crystallinity by graphitization, thereby elevating conductivity.

The vapor grown carbon fiber employed in the present invention preferably exhibits the following physical properties:

(i) Fiber diameter: 50 to 200 nm, preferably 80 to 180 nm;

(ii) Aspect ratio: 40 to 1,000, preferably 45 to 800, more preferably 65 to 800;

(iii) BET specific surface area: 5 to 100 m²/g, preferably 10 to 50 m²/g; and

(vi) Raman peak intensity ratio (I₀=I₁₃₆₀/I₁₅₈₀), wherein I¹⁵⁸⁰ represents a peak height at 1,580 cm⁻¹ and I₁₃₆₀ represents a peak height at 1,360 cm⁻¹ in a Raman scattering spectrum: 0.1 to 2, preferably 0.1 to 1.5.

In general, when the aspect ratio is small, thermal conductivity is poor and therefore high cycle performance (cooling time: five seconds or shorter) cannot be attained, even though warpage resistance may be attained. The fiber diameter and specific surface area are generally in inverse proportion. When the fiber diameter is 50 nm or less or the specific surface area is as large as 100 m²/g or more, flowability during melt molding decreases. In this case, residual stress remains in molded articles, thereby increasing warpage. Meanwhile, when the fiber diameter increases and the aspect ratio increases, warpage increases as in the case where a conventional carbon fiber is employed as a filler, and modification of molding conditions can no longer successfully control warpage. When the Raman intensity ratio is in excess of 2.0, carbon fiber per se has poor thermal conductivity, thereby decreasing solidification rate. Thus, high cycle performance cannot be attained.

No particular limitation is imposed on the synthetic resin employed in the present invention, and any synthetic resins may be employed so long as the resins satisfy desired heat resistance, thermal conductivity, and dynamic characteristics. Specific examples include engineering plastics, super-engineering plastics, plastics for general use and thermoplastic elastomer.

No particular limitation is imposed on the thermoplastic resin, and any resin used in molding can be employed. Examples include polyesters such as polyethylene terephthalate (PET), polybutylene terephthalate (PBT), polytrimethylene terephthalate (PTT), polyethylene naphthalate (PEN), and liquid crystal polyester (LCP); polyolefins such as polyethylene (PE), polypropylene (PP), polybutene-1 (PB-1), and polybutylene; polystyrene resins; polyoxymethylene (POM); polyamides (PA); polycarbonates (PC); poly(methyl methacerylate) (PMMA); poly(vinyl chloride) (PVC); polyphenylene ether (PPE); polyphenylene sulfide (PPS); polyimides (PI); polyamide-imides (PAI); polyether-imides (PEI); polysulfones (PSU); polyether-sulfones; polyketones (PK); polyether-ketones (PEK); polyether-ether-ketones (PEEK); polyether-ketone-ketones (PEKK); polyarylates (PAR); polyether-nitriles (PEN); and fluorine-containing resins such as polytetrafluoroethylene (PTFE). Examples further includes thermoplastic elastomers such as polystyrene-based elastomer, polyolefin-based elastomer, polyurethane-based elastomer, polyester-based elastomer, polyamide-based elastomer, polybutadiene-based elastomer, polyisoprene-based elastomer, and fluorine-containing elastomer; copolymers thereof; modified products thereof; and combinations of two or more species thereof.

In order to enhance impact resistance, other elastomer or rubber components may be added to the aforementioned thermoplastic resins.

Examples of elastomers generally employed for improving impact characteristics include olefin elastomers such as EPR and EPDM, styrene elastomer such as SBR comprising styrene-butadiene copolymer, silicone elastomer, nitrile elastomer, butadiene elastomer, urethane elastomer, nylon elastomer, ester elastomer, fluororesin elastomer, natural rubber, and modified product thereof to which a reactive site (e.g., double bond, carboxylic acid anhydride moiety) is introduced.

No particular limitation is imposed on the vapor grown carbon fiber content in the matrix resin, so long as the impact characteristic of the matrix are not impaired. The fiber content in the resin composition is 10 to 70 mass %, preferably 12 to 60 mass %, particularly preferably 15 to 50 mass %.

Into the composite material composition of the present invention, a variety of other resin additives may be incorporated, so long as the effects or achievement of objectives of the present invention are not affected. Examples of the resin additives which may be incorporated into the composition include a colorant, a plasticizer, a lubricant, a heat stabilizer, a photo-stabilizer, a UV-absorber, a filler, a foaming agent, a flame retardant and an anti-corrosive agent. These resin additives are preferably incorporated at a final stage of preparation of the conductive plastics of the present invention.

In the present invention, the method for mixing and kneading components for forming the composite material composition is a critical issue. Particularly, breakage of the vapor grown carbon fiber is to be suppressed to a minimum possible level, and the breakage rate is controlled to 20% or less, preferably 15% or less, more preferably 10% or less. The degree of breakage may be evaluated through comparison of aspect ratio before and after mixing/kneading (e.g., determined by observation under a SEM). The present inventors have carried out extensive studies on filling carbon fiber having a bulk density as remarkably small as 0.01 to 0.1 into the resin at high density, and have found that the following approach can be suitably employed.

Generally, when a thermoplastic resin and an inorganic filler are melt-kneaded, so-called dispersion mixing is employed. In the technique, high shear force is applied to aggregated inorganic filer filaments, thereby breaking the inorganic filler to form minute fragments, whereby the inorganic filer is uniformly dispersed in a molten resin. In order to generate such high shear force, a variety of kneaders are employed. Examples include a kneader based on a stone mill mechanism and a twin-screw (same rotation direction) extruder having kneading disks in a screw element for applying high shear force. However, when such a type of kneader is employed, vapor grown carbon fiber is broken during the kneading step. If a singe-screw kneader generating weak shear force is employed, breakage of carbon fiber is prevented, but carbon fiber fails to be uniformly dispersed. Therefore, in order to attain uniform dispersion while breakage of fiber is suppressed, a kneader (e.g., a pressure kneader) which attains dispersion over a long period of time without applying high shear force (i.e., assuring long residence time) is preferably employed.

Upon filling of an inorganic filler into a resin at high density, wetting of the inorganic filler with molten resin is also a critical issue, and it is essential to increase the interfacial area between the resin and the inorganic filler through continuously renewing the surface of the inorganic filler during melt-kneading. A conventional single-screw extruder and a twin-screw (same rotation direction) extruder are not suited for attaining such wetting conditions, since the extruders provide a short residence time, making high-density filling difficult. Furthermore, the vapor grown carbon fiber employed in the present invention has a bulk density as remarkably small as about 0.01 to 0.1, meaning that the fiber is not dense and readily entrains air. Thus, when a conventional single-screw extruder and a twin-screw (same rotation direction) extruder is employed, degassing is difficult and high-density filling cannot be attained. In the present invention, a batch-type pressure kneader is effectively employed in order to attain high-density filling while suppressing breakage of the carbon fiber to a minimum possible level. The thus-kneaded product obtained by use of a batch-type pressure kneader may be input to a single-screw extruder before solidification to be pelletized.

Alternatively, in place of sequentially using a batch-type pressure kneader and a single-screw extruder, a special single-screw-extruder; e.g., a reciprocating single-screw extruder (Co-kneader product of Coperion Buss), may be preferably used, which renews fiber surface without applying high shear force to the fiber, attains high dispersibility, degasses such a vapor grown carbon fiber which entrains considerable air, and attains high-density filling. In this case, components in predetermined amounts are mixed by means of a mixer such as a tumble mixer, and the mixture is pelletized by means of a reciprocating single-screw extruder.

In order to intentionally disturb alignment of vapor grown carbon fiber contained in the composite material composition during kneading or molding, a high-temperature mold must be employed for reducing melt viscosity of the resin. Thermal conductivity of the composite material composition is enhanced when the carbon fiber has a large aspect ratio and reduced degree of fiber alignment. Therefore, even when such a high-temperature mold is employed, cycle performance (cooling time) is not deteriorated, assuring high cycle performance.

Specifically, polyamide 66 (PA66, employed in the Examples below) is generally injection-molded at a mold temperature of 80° C. or lower. If the mold temperature is elevated to 100° C. or higher, the molding cycle (cooling time) is considerably prolonged. When kneading is performed according to the present invention, and even when molding is performed at a mold temperature (varying depending on the type of resin) at least 20° C. higher than a typical mold temperature (e.g., such a mold temperature that the time required for cooling the mold is five seconds and a non-defective production rate of 95% or higher is attained), the cooling time is not prolonged. In the non-defective production rate, non-defective products may be those having a warpage of 0.5 or less. The composition containing a vapor grown carbon fiber having a specific thermal conductivity exhibits high thermal conductivity (≧1 W/mK) so that, during solidification of molten resin (see FIG. 1), remaining heat is rapidly removed. Consequently, such a high cycle performance can be attained even when a high mold temperature is employed.

The composite material composition of the present invention exhibits excellent dynamic properties (e.g., strength and elastic modulus), electrical conductivity, thermal conductivity, sliding characteristics, and surface smoothness, as well as excellent precision-moldability (e.g., warpage resistance). Thus, the composite material composition is applicable to complicated parts used in the electrical and electronic industry, in the automobile industry and in other industries. When these articles are produced from the composition, any conventionally known molding method for conductive plastics or thermoplastic resin composites may be employed. Examples of the molding methods include injection molding and extrusion.

According to the present invention, a vapor grown carbon fiber having a high aspect ratio (≧40) and a synthetic resin are melt-kneaded while reduction in aspect ratio is suppressed to a minimum possible level, thereby attaining high filling density. Thus, the sliding member composition is obtained which exhibits durability under high temperature and heavy load; has a low friction coefficient (high wear resistance); rapidly releases generated heat by virtue of high thermal conductivity, inflicts no damage on the counter member even when the counter member is made of aluminum; and maintains its performance for a long period of time. Thus, the present invention provides remarkably high utility in the industry.

The sliding member composition according to the present invention maintains flowability possessed by the resin per se, and a sliding member produced from the composition exhibits excellent dynamic characteristics, heat resistance and thermal conductivity as well as excellent sliding characteristics (i.e., a small friction coefficient, low wear and a very high PV limit value). Thus, the sliding member finds a variety of uses in the automobile industry, in the electric/electronic industry and in other industries.

The vapor grown carbon fiber employed in the present invention may be produced by, for example, feeding a gasified organic compound with iron serving as a catalyst into an inert gas atmosphere at high-temperature (see, for example, Japanese Patent Application Laid-Open (kokai) No. 7-150419).

The thus-produced vapor grown carbon fiber may be used without performing any further treatment. Alternatively, the produced vapor grown carbon fiber subjected to heat treatment at 800 to 1,500° C. or graphitizing treatment may be employed.

The cross-section of the vapor grown carbon fiber may assume a perfect circle, an ellipse or a polygon. The carbon fiber may contain on its surface a carbonaceous substance deposited through pyrolysis of carbon. After completion of production, the vapor grown carbon fiber may be further treated at 2,000° C. or higher in order to enhance crystallinity by graphitization, thereby elevating conductivity.

The vapor grown carbon fiber employed in the present invention preferably exhibits the following physical properties:

(i) Fiber diameter: 50 to 200 nm, preferably 80 to 180 nm;

(ii) Aspect ratio: 40 to 1,000, preferably 45 to 800, more preferably 65 to 800;

(iii) BET specific surface area: 5 to 100 m²/g, preferably 10 to 50 m²/g; and

(vi) Raman peak intensity ratio (I₀=I₁₃₆₀/I₁₅₈₀), wherein I₁₅₈₀ represents a peak height at 1,580 cm^{-l} and I₁₃₆₀ represents a peak height at 1,360 cm⁻¹ in a Raman scattering spectrum: 0.1 to 2, preferably 0.1 to 1.5.

The aforementioned physical properties are closely related to the present invention as follows.

(i) and (iii): The fiber diameter and specific surface area provide similar effects but are in inverse proportion. When the fiber diameter is smaller than 50 nm or the specific surface area is 100 m²/g or more, aggregation energy of carbon filler increases, thereby failing to attain uniform dispersion of the carbon filler in the matrix resin. However, when these values fall within the ranges as mentioned in (i) and (iii), uniform dispersion can be attained. When the fiber diameter is 200 nm or more or the specific surface area is 5 m²/g or less, sliding characteristics on aluminum members are impaired.

(ii) When the aspect ratio is 40 or less, heat resistance (heat deflection temperature) does not increase, and surfaces of molded products are melted through friction. Thus, the PV limit value cannot be enhanced.

(iv) When the Raman peak intensity ratio is 2 or more, the graphite structure providing solid lubricity is reduced, thereby impairing sliding characteristics.

No particular limitation is imposed on the synthetic resin employed in the present invention, and any synthetic resins may be employed so long as the resins satisfy desired heat resistance, thermal conductivity and dynamic characteristics. Specific examples include engineering plastics, super-engineering plastics and thermosetting resins.

No particular limitation is imposed on the thermoplastic resin, and any resin used in molding can be employed. Examples include polyester resins such as polyethylene terephthalate (PET), polybutylene terephthalate (PBT), polytrimethylene terephthalate (PTT), polyethylene naphthalate (PEN), and liquid crystal polyester (LCP); polyolefins such as polypropylene (PP); syndiotactic polystyrene resin; polyoxymethylene (POM); polyamides (PA); polycarbonates (PC); polyphenylene ether (PPE); polyphenylene sulfide (PPS); polyimides (PI); polyamide-imides (PAI); polyether-imides (PEI); polysulfones (PSU); polyether-sulfones; polyketones (PK); polyether-ketones (PEK); polyether-ether-ketones (PEEK); polyether-ketone-ketones (PEKK); polyarylates (PAR); polyether-nitriles (PEN); and fluorine-containing resins such as polytetrafluoroethylene (PTFE) . Examples further includes copolymers thereof; modified products thereof; and combinations of two or more species thereof.

In order to enhance impact resistance, other elastomer or rubber components may be added to the aforementioned thermoplastic resins.

No particular limitation is imposed on the thermosetting resin, and any resin used in molding can be employed. Examples include unsaturated polyester resins, vinyl ester resins, epoxy resins, phenolic (resol) resins, urea-melamine resins and polyimide resins; copolymers thereof; modified products thereof; and combinations of two or more species thereof. In order to enhance impact resistance, an elastomer or a rubber component may be added to the aforementioned thermosetting resins.

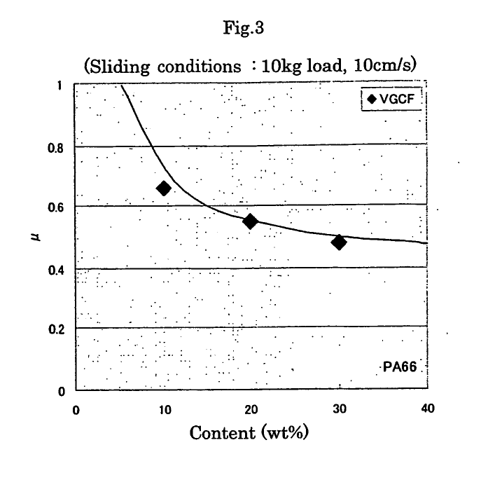

The vapor grown carbon fiber content in the sliding member composition is 10 to 70 mass %, preferably 12 to 60 mass %, more preferably 15 to 50 mass % (see FIG. 3).

Into the sliding member composition of the present invention, a variety of other resin additives may be incorporated in an arbitrary amount, so long as the effects or achievement of objectives of the present invention are not affected. Examples of the resin additives which may be incorporated into the composition include a colorant, a plasticizer, a lubricant, a heat stabilizer, a photo-stabilizer, a UV-absorber, a filler, a foaming agent, a flame retardant and an anti-corrosive agent. These resin additives are preferably incorporated at a final stage of preparation of the conductive plastics of the present invention.

In the present invention, the method for mixing and kneading components for forming the sliding member composition is a critical issue. Particularly, breakage of the vapor grown carbon fiber is to be suppressed to a minimum possible level, and the breakage rate is controlled to 20% or less, preferably 15% or less, more preferably 10% or less. The degree of breakage may be evaluated through comparison of aspect ratio before and after mixing/kneading (e.g., determined by observation under a SEM) . The present inventors have carried out extensive studies on filling carbon fiber having a bulk density as remarkably small as 0.01 to 0.1 into the resin at high density, and have found that the following approach can be suitably employed.

Generally, when a thermoplastic resin and an inorganic filler are melt-kneaded, so-called dispersion mixing is employed. In the technique, high shear force is applied to aggregated inorganic filer filaments, thereby breaking the inorganic filler to form minute fragments, whereby the inorganic filer is uniformly dispersed in a molten resin. In order to generate such high shear force, a variety of kneaders are employed. Examples include a kneader based on a stone mill mechanism and a twin-screw (same rotation direction) extruder having kneading disks in a screw element for applying high shear force. However, when such a type of kneader is employed, vapor grown carbon fiber is broken during the kneading step. If a singe-screw kneader generating weak shear force is employed, breakage of carbon fiber is prevented, but carbon fiber fails to be uniformly dispersed. Therefore, in order to attain uniform dispersion while breakage of fiber is suppressed, a kneader (e.g., a pressure kneader) which attains dispersion over a long period of time without applying high shear force (i.e., assuring long residence time) is preferably employed.

Upon filling an inorganic filler into a resin at high density, wetting of the inorganic filler with molten resin is also a critical issue, and it is essential to increase the interfacial area between the resin and the inorganic filler through continuously renewing the surface of the inorganic filler during melt-kneading. A conventional single-screw extruder and a twin-screw (same rotation direction) extruder are not suited for attaining such wetting conditions, since the extruders provide a short residence time, making high-density filling difficult. Furthermore, the vapor grown carbon fiber employed in the present invention has a bulk density as remarkably small as about 0.01 to 0.1, meaning that the fiber is not dense and readily entrains air. Thus, when a conventional single-screw extruder and a twin-screw (same rotation direction) extruder is employed, degassing is difficult and high-density filling cannot be attained. In the present invention, a batch-type pressure kneader is effectively employed in order to attain high-density filling while suppressing breakage of the carbon fiber to a minimum possible level. The thus-kneaded product obtained by use of a batch-type pressure kneader may be input to a single-screw extruder before solidification to be pelletized.

Alternatively, in place of sequentially using a batch-type pressure kneader and a single-screw extruder, a special single-screw-extruder; e.g., a reciprocating single-screw extruder (Co-kneader product of Coperion Buss), may be preferably used, which renews fiber surface without applying high shear force to the fiber, attains high dispersibility, degasses such a vapor grown carbon fiber which entrains considerable air, and attains high-density filling. In this case, components in predetermined amounts are mixed by means of a mixer such as a tumble mixer, and the mixture is pelletized by means of a reciprocating single-screw extruder.

The sliding member composition according to the present invention exhibits excellent dynamic characteristics, heat resistance, thermal conductivity, sliding characteristics (small friction coefficient and wear) and a remarkably large PV limit value.

In other words, the sliding member composition of the present inventions provides a sliding member having a remarkably high critical PV (referred to a limit value of a load indicated by a product of “P” and “V”, where fusion or burnout of the sliding member occurs when a peripheral velocity V (cm/sec) of the member exceeds a specific value at a certain load P (kg/cm²).

Meanwhile, in general, synthetic resin materials are disadvantageous in mechanical properties (e.g., heat resistance and rigidity) and thermal conductivity as compared with metallic materials. By incorporating a specific vapor grown carbon fiber while suppressing breakage of the fiber, the sliding member composition of the present invention have the following advantages.

(1) Even when the composition contains a thermoplastic resin, a heat deflection temperature of 160° C. or higher, preferably 180° C. or higher, more preferably 200° C. or higher can be attained.

(2) Through incorporation of vapor grown carbon fiber, the composition based on synthetic resin readily assures a kinetic friction coefficient of 0.6 or less, preferably 0.5 or less. Thus, the relative wear amount can be suppressed.

(3) Through suppressing of breakage of vapor grown carbon fiber, a thermal conductivity of 1 W/mK or more, preferably 1.8 W/mK or more, more preferably 2 W/mK or more can be readily attained. Such thermal conductivity is one of the conditions for attaining excellent heat dispersion even under high-speed sliding conditions and for preventing temperature increase in a sliding portion.

(4) The composition assures a flexural modulus of 4,000 MPa or more, preferably 5,000 MPa or more, more preferably 5,500 MPa or more. This means that the synthetic resin composition can be employed as a sliding member under relatively heavy load.

(5) One characteristic feature of the sliding member composition of the present invention is that high flowability can be maintained even through the composition contains a large amount of specific vapor grown carbon fiber. Such property is remarkably essential for maintaining high productivity and precision of molded products (i.e. sliding member) obtained from the composition. Thus, a remarkably excellent sliding member composition can be provided.

(6) The sliding member composition of the present invention is basically formed of synthetic resin and vapor grown carbon fiber. Thus, since the composition has self-lubricating property that is required for a sliding member, the sliding member can be used without adding any lubricating oil. In addition, by virtue of a small rigidity of the composition per se, the sliding member can prevent damage to a soft counter member such an aluminum member.

Accordingly, the sliding member composition of the present invention finds a variety of uses in the automobile industry, in the electric/electronic industry and in other industries. When these articles are produced from the composition, any conventionally known plastic molding method can be employed. Examples of the molding methods include injection molding, blow molding, extrusion, sheet molding, heat molding, rotational molding, lamination molding and transfer molding.

### EXAMPLES

The present invention will next be described in more detail by way of examples, which should not be construed as limiting the invention thereto.
(1) An electrically conductive filler and composition thereof:

### Examples 1 to 9 and Comparative Examples 1 to 7:

Table 1 shows formulations of compositions of the Examples and the Comparative Examples. Each composition was prepared by melt-kneading the resin and the electrically conductive filler in amounts listed in Table 1, and the kneaded product was injection-molded to thereby form plate pieces for volume resistivity measurement.

The resins, electrically conductive fillers, determination of the size of an aggregated mass of the electrically conductive filler, kneading conditions, molding conditions, and evaluation methods employed in the Examples are below-described in detail. Volume resistivity, presence of aggregated masses, and breakage rate of fiber in the compositions obtained in the Examples and the Comparative Examples are also shown in Table 1.

FIG. 1 shows an electron microscopic photograph (×2,000) of the conductive resin composition obtained in Example 3.

Kneading Method:

i) Thermoplastic resin

Kneading was performed at 270° C. by use of a twin-screw extruder (same rotation direction) (PCM 30, product of Ikegai Corporation).
ii) Thermosetting resin

Kneading was performed at 60° C. by use of a pressure kneader (product of Toshin Co., Ltd., kneading capacity: 10 L).

Molding Method:

i) Thermoplastic resin

Each thermoplastic resin was molded into plate test pieces (100×100×2 mm (thickness) ) by means of an injection molding machine (Sicap, clamping force: 75 tons, product of Sumitomo Heavy Industries, Ltd.) at molding temperature of 280° C. and a mold temperature of 130° C.
ii) Thermosetting resin

Each thermosetting resin was molded into plate test pieces (100×100×2 mm (thickness)) by means of an injection-molding apparatus (M-70C-TS, product of Meiki Co., Ltd.) at molding temperature of 120° C. and a mold temperature of 150° C.

Vapor Grown Carbon Fiber:

i) VGCF (registered trademark), vapor grown carbon fiber, product of Showa Denko K. K. (mean fiber diameter: 150 nm, mean fiber length: 10 μm, specific surface area: 13 m²/g, aspect ratio: 67, I⁰=0.2) was used. A product therefrom having a mean fiber length of 5 μm (aspect ratio: 33) was prepared through pulverization by means of a jet-mill.
ii) VGCF-S, vapor grown carbon fiber, product of Showa Denko K. K. (mean fiber diameter: 100 nm, mean fiber length: 11 μm, specific surface area: 20 m²/g, aspect ratio: 110, I⁰=0.2) was used. A product therefrom having a mean fiber length of 5 μm (aspect ratio: 50) was prepared through pulverization by means of a jet-mill.
iii) VGNF (registered trademark), vapor grown carbon fiber, product of Showa Denko K. K. (mean fiber diameter: 80 nm, mean fiber length: 10 μm, specific surface area: 25 m²/g, aspect ratio: 125, I₀=0.2) was used. A product therefrom having a mean fiber length of 5 μm (aspect ratio: 63) was prepared through pulverization by means of a jet-mill.
iv) Carbon nanotube (CNT: hollow carbon fibril): PC masterbatch (RMB6015-00), product of Hyperion Catalysis, (CNT content: 15 mass %) was used (mean fiber diameter: 10 nm, mean fiber length: 5 μm, specific surface area: 250 m²/g (in the relevant catalogue), and aspect ratio: 500).
   Synthetic Resins Employed:
i) Thermoplastic resin

Polycarbonate resin (PC) (Panlite L-1225L, product of Teijin Chemicals, Ltd.)
ii) Thermosetting resin

Allyl ester resin (AA 101, product of Showa Denko K. K., viscosity 630,000 cps (30° C.)), in combination with dicumyl peroxide (Percumyl D, product of Nippon Oil & Fats Co., Ltd.) serving as an organic peroxide

Determination of Physical Properties:

i) Volume resistivity: Measured in accordance with JIS K7194, through the 4-probe method.
ii) Aggregated mass of carbon fiber filaments: A broken plane of strands obtained by kneading by means of a twin-screw extruder (same rotation direction) was observed under an electron microscope (SEM) (×2,000). The presence of an aggregated mass of filaments was evaluated as follows according to the size (longer diameter) of an aggregated mass:

∘: smaller than 0.5 μm

Δ: 0.5 to 5 μm (not inclusive)

X: 5 μm or more

iii) Breakage rate (%) of carbon fiber: determined from the following equation:

Breakage rate (%) of carbon fiber={1-(carbon fiber aspect ratio in molded article/carbon fiber aspect ratio before mixing by kneading)}×100, wherein each aspect ratio was measured through observation under an electron microscope (SEM), followed by calculation.

iv) Raman scattering spectra: a peak intensity ratio (I₀=I₁₃₆₀/I₁₅₈₀) was measured, wherein I₁₅₈₀ represents a peak height at 1,580 cm⁻¹ and I₁₃₆₀ represents a peak height at 1,360 cm⁻¹.

TABLE 1

| | | | | | | | | | | |
|---|---|---|---|---|---|---|---|---|---|---|
| | | | Conduc- | | Specific | | Fiber | Volume | | Breakage |
| | | Amount | tive | Amount | surface | Aspect | length | resistiv- | Cohered | rate |
| No. | Resin | mass % | filler | mass % | area m²/g | ratio | μm | ity Ω · cm | mass | % |

Examples

| | | | | | | | | | | |
|---|---|---|---|---|---|---|---|---|---|---|
| 1 | PC | 95 | VGCF-S | 5 | 20 | 110 | 10 | 4.0 × 10⁸ | ◯ | 4 |
| 2 | PC | 95 | VGNF | 5 | 25 | 125 | 10 | 1.0 × 10⁸ | ◯ | 3 |
| 3 | PC | 90 | VGCF-S | 10 | 20 | 110 | 10 | 2.5 × 10⁴ | ◯ | 8 |
| 4 | PC | 80 | VGCF | 20 | 13 | 67 | 10 | 5.0 × 10⁴ | ◯ | 5 |
| 5 | PC | 40 | VGCF | 60 | 13 | 67 | 10 | 2.0 × 10⁻¹ | ◯ | 13 |
| 6 | Allyl | 95 | VGCF-S | 5 | 20 | 110 | 10 | 2.0 × 10⁴ | ◯ | 2 |
| | ester | | | | | | | | | |
| 7 | Allyl | 95 | VGNF | 5 | 25 | 125 | 10 | 9.0 × 10³ | ◯ | 3 |
| | ester | | | | | | | | | |
| 8 | Allyl | 80 | VGCF | 20 | 13 | 67 | 10 | 1.5 × 10¹ | ◯ | 4 |
| | ester | | | | | | | | | |
| 9 | Allyl | 40 | VGCF | 60 | 13 | 67 | 10 | 3.5 × 10⁻² | ◯ | 10 |
| | ester | | | | | | | | | |

Comparative Examples

| | | | | | | | | | | |
|---|---|---|---|---|---|---|---|---|---|---|
| 1 | PC | 95 | VGCF-S | 5 | 20 | 50 | 5 | 2.0 × 10¹⁵ | ◯ | 2 |
| 2 | PC | 90 | VGCF-S | 10 | 20 | 50 | 5 | 8.0 × 10⁸ | ◯ | 4 |
| 3 | PC | 95 | VGNF | 5 | 25 | 63 | 5 | 4.0 × 10¹⁴ | Δ | 2 |
| 4 | PC | 95 | CNT | 5 | 250 | 500 | 5 | 3.0 × 10⁹ | X | 80 |
| 5 | PC | 80 | VGCF | 20 | 13 | 33 | 5 | 4.0 × 10⁵ | ◯ | 3 |
| 6 | PC | 40 | VGCF | 60 | 13 | 33 | 5 | 5.0 × 10¹ | Δ | 10 |
| 7 | Allyl | 95 | VGCF-S | 5 | 20 | 50 | 5 | 6.0 × 10¹² | ◯ | 1 |
| | ester | | | | | | | | | |

### Examples 10 to 19 and Comparative Examples 8 to 14:

Tables 2 and 3 show formulations of compositions of the Examples and the Comparative Examples. Each composition was prepared by melt-kneading a resin and a conductive filler by means of a kneading extruder, which enables uniform dispersion of the fibrous filler in the resin without applying high shear force. The kneaded product was melt-kneaded suppresses breakage of low-bulk-density fiber and attains high filling density in such a manner that the aspect ratio is not decreased. The thus-kneaded product was injection-molded, to thereby prepare plate test pieces (for measuring warpage, mold shrinkage and thermal conductivity). The resins, conductive fillers, kneading conditions, molding conditions, and evaluation methods employed in the Examples are below-described in detail. The test results of the Examples and Comparative Examples are shown in Table 4.

Kneading Method:

Thermoplastic Resin

The components were melt-kneaded by means of a pressure kneader (product of Toshin Co., Ltd., mixing capacity: 10 L), and the kneaded product was pelletized by means of a single-screw extruder (30 mmφ, product of Tanabe Plastics).

Molding Method:

Thermoplastic Resin

Each thermoplastic resin was molded into test pieces by means of an injection molding machine (Sicap, clamping force: 75 tons, product of Sumitomo Heavy Industries, Ltd.).

Vapor grown carbon fiber:

i) VGCF (registered trademark), vapor grown carbon fiber, product of Showa Denko K. K. (fiber diameter: 0.1 to 0.2 μm, fiber length: 10 μm) was used (bulk density: 0.04, specific surface area: 13 m²/g, aspect ratio: 70)
ii) VGNF (registered trademark), vapor grown carbon fiber, product of Showa Denko K. K. (fiber diameter: 0.08 to 0.12 μm, fiber length: 50 μm) was used (bulk density: 0.02, specific surface area: 20 m²/g, aspect ratio: 500).
iii) VGCF-H, vapor grown carbon fiber, product of Showa Denko K. K. (fiber diameter: 0.1 to 0.2 μm, fiber length: 10 μm) was used (bulk density: 0.08, specific surface area: 13 m²/g, aspect ratio: 70).
iv) VGCF pulverized product (prepared by pulverizing the above VGCF by means of a pulverizer so as to be adjusted to an aspect ratio of 35) was used (bulk density: 0.12, specific surface area: 14 m²/g, aspect ratio: 35).
   Carbon fiber (CF):

Besfight HTA-C6-SR (conductive filler, product of Toho Tenax, fiber diameter: 7 μm, fiber length: 6 mm, specific surface area: 2 m²/g, bulk density: 0.8) was used.

Carbon Nanotube: CNT (hollow carbon fibril)

PA66 masterbatch (RMB4620-00), product of Hyperion Catalysis, (CNT content: 20 mass %) was used (specific surface area: 250 m²/g, fiber diameter: 10 nm, fiber length: 5 μm).

Plastics Employed:

i) Thermoplastic resin

Polyamide 66 (PA 66) (Amilan CM 3001, product of Toray Industries, Inc.)
ii) Ethylenic elastomer (Adtex ET182, product of Mitsubishi Chemical Co., Ltd.)
   Evaluation of Physical Properties:
i) Mold shrinkage factor: A test plate (100×100×2 mm (thickness)) was evaluated (film gate: 0.5 mm) in terms of mold shrinkage factor in the machine direction (M direction) and that in the transverse direction (T direction) . The ratio (M/T) is referred to as anisotropic ratio in mold shrinkage factor.
ii) Warpage: The same test plate as employed for measuring mold shrinkage factor was used. A side of the plate was brought into contact with a horizontal flat plane, and the maximum displacement (mm) from the flat plane was measured.
iii) Thermal conductivity: Measured through the thermal beam method by means of a rapid thermal conductivity meter, product of Kyoto Electronics Manufacturing Co., Ltd. Each test sample was five stacked plates (each plate: 100×100×2 mm (thickness)).
iv) Aspect ratio of carbon fiber contained in molded products: Each test piece was heated in a furnace under inert gas (Ar) at 600° C., and a remaining fibrous product was observed under an electron microscope (SEM), whereby the aspect ratio was determined.
v) Measurement of melt viscosity (Capirograph): A Capirograph, a capillary type rheometer, is employed for measurement in accordance with JIS K7119 to determine flowability of each polymer.
vi) Cooling time: Time required for cooling a mold employed in injection molding to form the aforementioned plates was measured. A short cooling time means a high cycle performance.
vii) Specific surface area: Determined through the nitrogen adsorption BET method.
viii) Breakage rate (%) of carbon fiber: A ratio of aspect ratio of carbon fiber before mixing/kneading to aspect ratio of carbon fiber in a molded article of the composition

Breakage rate (%) of carbon fiber={1-(carbon fiber aspect ratio in a molded article/carbon fiber aspect ratio before mixing by kneading)}×100

TABLE 2

| | | | | | Molding | Melt | Mold |
|---|---|---|---|---|---|---|---|
| | | Amount | Conductive | Amount | temperature | viscosity of | temperature |
| Ex. | Resin | mass % | filler | mass % | ° C. | resin Pa · s | ° C. |
| 10 | PA66 | 90 | VGCF | 10 | 280 | 450 | 100 |
| 11 | PA66 | 80 | VGCF | 20 | 280 | 450 | 120 |
| 12 | PA66 | 80 | VGCF | 20 | 270 | 550 | 120 |
| 13 | PA66 | 70 | VGCF | 30 | 280 | 450 | 120 |
| 14 | PA66 | 70 | VGCF | 30 | 270 | 550 | 120 |
| 15 | PA66 | 50 | VGCF | 50 | 300 | 330 | 150 |
| 16 | PA66 | 30 | VGCF | 70 | 320 | 150 | 170 |
| 17 | PA66 | 70 | VGCH-H | 30 | 280 | 450 | 120 |
| 18 | PA66 | 80 | VGNF | 20 | 300 | 330 | 150 |
| 19 | PA66/ | 64/16 | VGCF | 20 | 300 | 330 | 100 |
| | ET182 | | | | | | |

TABLE 3

| | | | | | Molding | Melt | Mold |
|---|---|---|---|---|---|---|---|
| Comp. | | Amount | Conductive | Amount | temperature | viscosity of | temperature |
| Ex. | Resin | mass % | filler | mass % | ° C. | resin Pa · s | ° C. |
| 8 | PA66 | 100 | | | 280 | 450 | 100 |
| 9 | PA66 | 70 | VGCF | 30 | 265 | 650 | 120 |
| 10 | PA66 | 95 | VGCF | 5 | 280 | 450 | 100 |
| 11 | PA66 | 90 | CF | 10 | 280 | 450 | 100 |
| 12 | PA66 | 80 | CF | 20 | 280 | 450 | 120 |
| 13 | PA66 | 90 | Pulverized | 10 | 280 | 450 | 100 |
| | | | VGCF | | | | |
| 14 | PA66 | 80 | CNT | 20 | 300 | 330 | 150 |

TABLE 4

| | Anisotropic ratio | | Thermal | Cooling | Aspect ratio of | |
|---|---|---|---|---|---|---|
| | in mold shrinkage | Warpage | conductivity | time | carbon fiber in | Breakage rate of |
| Ex. | factor (M/T) | (mm) | (W/mK) | (sec) | molded products | carbon fiber (%) |
| 10 | 1.0 | 0.02 | 1.54 | 5 | 70 | 0 |
| 11 | 0.95 | 0.05 | 2.22 | 5 | 69 | 1 |
| 12 | 0.70 | 0.08 | 2.12 | 5 | 69 | 1 |
| 13 | 0.90 | 0.02 | 2.95 | 5 | 68 | 3 |
| 14 | 0.55 | 0.05 | 2.82 | 5 | 65 | 7 |
| 15 | 0.80 | 0.00 | 5.15 | 5 | 65 | 7 |
| 16 | 0.70 | 0.00 | 7.50 | 5 | 60 | 14 |
| 17 | 0.90 | 0.03 | 2.90 | 5 | 68 | 3 |
| 18 | 0.90 | 0.04 | 2.80 | 5 | 470 | 6 |
| 19 | 0.75 | 0.06 | 2.64 | 5 | 68 | 3 |

TABLE 5

| | | | | | Aspect ratio | |
|---|---|---|---|---|---|---|
| | | | | | of carbon | |
| | Anisotropic ratio | | Thermal | Cooling | fiber in | |
| Comp. | in mold shrinkage | Warpage | conductivity | time | molded | Breakage rate of |
| Ex. | factor (M/T) | (mm) | (W/mK) | (sec) | products | carbon fiber (%) |
| 8 | 1.0 | 1.20 | 0.33 | 15 | | |
| 9 | 0.45 | 2.50 | 2.20 | 5 | 50 | 29 |
| 10 | 0.98 | 0.54 | 0.86 | 10 | 70 | 0 |
| 11 | 0.26 | 4.50 | 0.45 | 10 | 450 | 47 |
| 12 | 0.08 | 5.05 | 0.63 | 5 | 350 | 59 |
| 13 | 1.0 | 0.30 | 0.95 | 10 | 35 | 0 |
| 14 | 0.45 | 1.55 | 1.54 | 5 | 20 | 96 |

### Examples 20 to 28 and Comparative Examples 15 to 22:

Tables 6 and 7 show formulations of compositions of the Examples and the Comparative Examples. Each composition was prepared by melt-kneading the resin and the conductive filler in amounts listed in Tables 6 and 7 through melt-kneading without lowering the aspect ratio of the filler. The kneaded product was injection-molded to thereby form test pieces (for HDT test, bending test and thermal conductivity measurement). The resins, conductive fillers, kneading conditions, molding conditions, and evaluation methods employed in the Examples are below-described in detail. The test results of the Examples and Comparative Examples are shown in Tables 8 and 9.

Kneading Method:

Apparatus Employed:

The components were melt-kneaded by means of a pressure kneader (product of Toshin Co., Ltd., mixing capacity: 10 L), and the kneaded product was pelletized by means of a single-screw extruder (30 mmφ, product of Tanabe Plastics).

Molding Method:

i) Thermoplastic resin

Each thermoplastic resin was molded into test pieces by means of an injection molding machine (Sicap, clamping force: 75 tons, product of Sumitomo Heavy Industries, Ltd.),
ii) Thermosetting resin

Each thermosetting resin was molded into test pieces by means of a molding machine (M-70C-TS, product of Meiki Co., Ltd.)

Vapor grown carbon fiber:

i) VGCF (registered trademark), vapor grown carbon fiber, product of Showa Denko K. K. (fiber diameter: 0.1 to 0.2 μm, fiber length: 10 μm) was used (bulk density: 0.04, specific surface area: 13 m²/g, aspect ratio: 70).
ii) VGNF (registered trademark), vapor grown carbon fiber, product of Showa Denko K. K. (fiber diameter: 0.08 to 0.12 μm, fiber length: 50 μm) was used (bulk density: 0.02, specific surface area: 20 m²/g, aspect ratio: 500).
iii) Vapor grown carbon fiber-H, vapor grown carbon fiber, product of Showa Denko K. K. (fiber diameter: 0.1 to 0.2 μm, fiber length: 10 μm) was used (bulk density: 0.08, specific surface area: 13 m²/g, aspect ratio: 70).
iv) Vapor grown carbon fiber pulverized product (prepared by pulverizing the vapor grown carbon fiber by means of a pulverizer so as to be adjusted to an aspect ratio of 35) was used (bulk density: 0.12, specific surface area: 14 m²/g, aspect ratio: 35).
   Carbon Fiber (CF):

Besfight HTA-C6-SR (conductive filler, product of Toho Tenax, fiber diameter: 7 μm, fiber length: 6 mm, specific surface area: 2 m²/g, bulk density: 0.8) was used.

Carbon Nanotube: CNT (Hollow Carbon Fibril):

PA66 masterbatch (RMB4620-00), product of Hyperion Catalysis, (CNT content: 20 mass %) was used (specific surface area: 250 m²/g, fiber diameter: 10 nm, fiber length: 5 μm).

Plastics Employed:

i) Thermoplastic resin

Polyamide 66 (PA 66) (Amilan CM 3001, product of Toray Industries, Inc.)

Polyphenylene sulfide (PPS) (Susteel B385, product of Tosoh Corporation)
ii) Thermosetting resin

Allyl ester resin (AA 101, product of Showa Denko K. K.) (viscosity 630,000 cps (30° C.), with an organic peroxide: dicumyl peroxide (Percumyl D, Nippon Oil & Fats Co., Ltd.)

Evaluation of Physical Properties:

i) Sliding property: Kinetic friction coefficient and wear amount were measured by means of a thrust wear tester (product of Toyo Seiki) using an aluminum counter member. Each test piece was a cut plate (100×100×2 mm (thickness)). The wear amount of the aluminum member was determined after sliding for two hours.
ii) Heat deflection temperature (HDT) (under heavy load): Measured in accordance with ASTM D-648.
iii) Flexural modulus: Measured in accordance with ASTM D-790.
iv) Thermal conductivity: Measured through the thermal beam method by means of a rapid thermal conductivity meter, product of Kyoto Electronics Manufacturing Co., Ltd.). Each test sample was five stacked plates (each plate: (100×100×2 mm (thickness)).
v) Aspect ratio of carbon fiber contained in molded products: Each test piece was heated in a furnace under inert gas (Ar) at 600° C., and a remaining fibrous product was observed under an electron microscope (SEM), whereby the aspect ratio was determined.
vi) PV limit value: The load was changed at a constant wear rate of 30 cm/sec. Two hours after sliding with load application, the wear surface was observed for evaluation.
vii) Flowability of composition: MI (melt index) was measured at 320° C. in the case of PPS resin, 280° C. in the case of PA66 resin, and 60° C. in the case of allyl ester resin. The amount of the flown composition under a load of 2.16 kg for 10 minutes was measured.
viii) Breakage rate (%) of carbon fiber: A ratio of aspect ratio of carbon fiber before mixing/kneading to aspect ratio of carbon fiber in a molded article of the composition

Breakage rate (%) of carbon fiber={1-(carbon fiber aspect ratio in a molded article/carbon fiber aspect ratio before mixing by kneading)}×100

TABLE 6

| Ex. | Resin | Amount mass % | Conductive filler | Amount mass % |
|---|---|---|---|---|
| 20 | PPS | 80 | VGCF | 20 |
| 21 | PPS | 70 | VGCF | 30 |
| 22 | PPS | 50 | VGCF | 50 |
| 23 | PPS | 30 | VGCF | 70 |
| 24 | PPS | 70 | VGCF-H | 30 |
| 25 | PPS | 80 | VGNF | 20 |
| 26 | PA66 | 80 | VGCF | 20 |
| 27 | PA66 | 70 | VGCF | 30 |
| 28 | Allyl | 70 | VGCF | 30 |
| | ester | | | |

TABLE 7

| Comp. | | Amount | | Amount |
|---|---|---|---|---|
| Ex. | Resin | mass % | Conductive filler | mass % |
| 15 | PPS | 90 | VGCF | 10 |
| 16 | PA66 | 100 | | |
| 17 | PA66 | 90 | VGCF | 10 |
| 18 | PA66 | 50 | Pulverized VGCF | 50 |
| 19 | PA66 | 90 | Carbon Fiber CF | 10 |
| 20 | PA66 | 80 | Carbon Fiber CF | 20 |
| 21 | PA66 | 80 | CNT | 20 |
| 22 | Allyl | 90 | VGCF | 10 |
| | ester | | | |

TABLE 8

| | Sliding Characteristics | | | | | | | | | |
|---|---|---|---|---|---|---|---|---|---|---|
| | Kinetic | Rela- | | Wear of | HDT | | Flow- | Thermal | Aspect | Breakage |
| | fric- | tive | PV | Al | heavy | Flexural | ability | conduc- | ratio (in | rate of |
| | tion co- | wear | limit | material | load | modulus | (g/ | tivity | molded | carbon |
| Ex. | efficient | amount | value | (mg) | (° C.) | MPa | 10 min) | (W/mK) | products) | fiber (%) |
| 20 | 0.55 | 0.77 | 600 | 0 | 190 | 5,530 | 50 | 2.25 | 68 | 3 |
| 21 | 0.40 | 0.68 | 650 | 0 | 210 | 6,770 | 30 | 3.05 | 67 | 4 |
| 22 | 0.30 | 0.50 | 800 | 0 | 245 | 9,630 | 10 | 5.15 | 63 | 10 |
| 23 | 0.20 | 0.30 | 800 | 0 | 250< | 11,750 | 3 | 7.50 | 60 | 14 |
| 24 | 0.35 | 0.65 | 600 | 0 | 250< | 6,630 | 40 | 2.85 | 66 | 14 |
| 25 | 0.50 | 0.72 | 650 | 0 | 220 | 7,560 | 45 | 2.45 | 460 | 8 |
| 26 | 0.60 | 1.10 | 400 | 0 | 195 | 4,270 | 40 | 2.22 | 69 | 1 |
| 27 | 0.48 | 0.85 | 500 | 0 | 230 | 5,440 | 25 | 2.95 | 68 | 3 |
| 28 | 0.52 | 1.20 | 400 | 0 | 180 | 5,200 | 50 | 3.10 | 69 | 1 |

Relative wear amount: x10⁻⁵ mm³/Nm;
critical PV: kgf/cm² · cm/s

TABLE 9

| | Sliding Characteristics | | | | | | | | | |
|---|---|---|---|---|---|---|---|---|---|---|
| | Kinetic | Rela- | | Wear of | HDT | | Flow- | Thermal | Aspect | Breakage |
| | fric- | tive | PV | Al | heavy | Flexural | ability | conduc- | ratio (in | rate of |
| Comp. | tion co- | wear | limit | material | load | modulus | g/ | tivity | molded | carbon |
| Ex. | efficient | amount | value | (mg) | (° C.) | MPa | 10 min | W/mK | products) | fiber (%) |
| 15 | 0.61 | 0.84 | 400 | 0 | 126 | 4,400 | 80 | 1.52 | 69 | 1 |
| 16 | 1.50 | 2.84 | 50 | 0 | 72 | 2,970 | 50 | 0.33 | | |
| 17 | 0.66 | 0.98 | 200 | 0 | 95 | 3,430 | 50 | 1.54 | 69 | 1 |
| 18 | 0.30 | 0.65 | 200 | 0 | 155 | 7,300 | 20 | 2.15 | 29 | 17 |
| 19 | 0.75 | 1.21 | 500 | 10 | 247 | 8,320 | 50 | 0.45 | 450 | 47 |
| 20 | 0.52 | 1.03 | 500 | 20 | 250 | 13,580 | 35 | 0.63 | 350 | 59 |
| 21 | 0.60 | 1.56 | 350 | 0 | 165 | 3,500 | 15 | 1.54 | 20 | 96 |
| 22 | 0.85 | 1.81 | 200 | 0 | 175 | 3,850 | 70 | 1.35 | 70 | 0 |

Relative wear amount: x10⁻⁵ mm³/Nm;
critical PV: kgf/cm² · cm/s

### INDUSTRIAL APPLICABILITY

According to the present invention, a vapor grown carbon fiber having a high aspect ratio and a thermoplastic resin are melt-kneaded while reduction in aspect ratio is suppressed to a minimum possible level, and alignment of the vapor grown carbon fiber contained in the resin is impeded through injection-molding the composition of a low melt viscosity, thereby attaining excellent cycle performance of the composite material composition. Thus, the present invention provides remarkably high utility in the industry.

The composite material composition according to the present invention, having high cycle performance, exhibits excellent dynamic properties (e.g., strength and elastic modulus), electrical conductivity, thermal conductivity, sliding characteristics and surface smoothness, as well as precision-moldability (e.g., warpage resistance) . Thus, the composite material composition is applicable to complicated parts used in the electrical and electronic industry, in the automobile industry and in other industries.

The composite material composition of the present invention may be applied to containers for transporting semiconductors (e.g., IC trays and trays for a hard disk head) among antistatic articles, and precision-sliding members for use in OA apparatuses (e.g., copying machines and printers) among structural parts.

A resin composite material employing carbon fiber for the purpose of improving dynamic properties of the composite material has been widely used in a variety of industries including the aerospace industry and the automobile industry, in sporting goods and in industrial materials. Carbon fiber employed as a filler in such a resin composite material is generally produced by baking acrylic fiber or pitch-based fiber. A composite material containing such carbon fiber exhibits excellent dynamic properties and heat resistance, but has poor flowability and unsatisfactory wear resistance. Therefore, when such a composite material is employed as a sliding member for a variety of industrial purposes, the sliding member has disadvantages in productivity and dimensional precision and has a shortened service life, and has not always achieved the desired results in practical use. Steel, which is generally employed as a counter material of a sliding member, is likely to be replaced by a lightweight, soft material such as aluminum. A sliding member produced from the sliding member composition of the present invention does not cause damage to aluminum, and can be employed with high safety.

1. A conductive filler for a conductive resin, characterized by comprising a vapor grown carbon fiber having a specific surface area of 10 to 50 m²/g and an aspect ratio of 65 to 1,000.

2. The conductive filler for a conductive resin as claimed in claim 1, characterized by comprising a vapor grown carbon fiber having a specific surface area of 15 to 40 m2 /g and an aspect ratio of 110 to 200.

3. The conductive filler as claimed in claim 1, wherein the vapor grown carbon fiber has a fiber diameter of 50 to 200 nm, a mean fiber length of 10 μm or more, and a peak intensity ratio (I₀=I₁₃₆₀/I₁₅₈₀)of 0.1 to 1, wherein I₁₁₅₈ represents a peak height at 1,580 cm⁻¹ and I₁₃₆₀ represents a peak height at 1,360 cm⁻¹ in a Raman scattering spectrum.

4. A conductive resin composition comprising the conductive filler as claimed in claim 1 in a matrix resin, which composition contains the conductive filler in an amount of 1 to 70 mass %.

5. The conductive resin composite composition as claimed in claim 4, wherein the matrix resin is at least one species selected from thermoplastic resin and thermosetting resin.

6. A method for producing the conductive resin composition as claimed in claim 4, comprising melt-mixing a conductive filler composed of vapor grown carbon fiber into a matrix resin, characterized in that breakage rate of the vapor grown carbon fiber during melt-mixing is suppressed to 20% or less.

7. The method for producing a conductive resin composition as claimed in claim 6, further comprising monitoring the mixture under an electron microscope, so that the melt-mixing is performed without generating an aggregated mass of vapor grown carbon fiber.

8. The method for producing a conductive resin composition as claimed in claim 6, wherein melt-mixing is performed by means of a twin-screw extruder (same rotation direction) or a pressure kneader.

9. A synthetic resin molded article comprising the conductive resin composition as claimed in claim 4.

10. A container for electric and electronic parts comprising the conductive resin composition as claimed in claim 4.

11. A conductive sliding member comprising the conductive resin composition as claimed in claim 4.

12. A conductive thermal-conducting member comprising the conductive resin composition as claimed in claim 4.

13. A composite material composition produced by kneading a matrix synthetic resin and a vapor grown carbon fiber, wherein the vapor grown carbon fiber has a fiber diameter of 50 to 200 nm, an aspect ratio of 40 to 1,000, and a peak intensity ratio (I₀=I₁₃₆₀/I₁₅₈₀) of 0.1 to 1, wherein I₁₅₈₀ represents a peak height at 1,580 cm⁻¹ and 11360 represent peak height at 1,360 cm⁻¹ in a Raman scattering spectrum, and the composition exhibits an anisotropic ratio in mold shrinkage of 0.5 or more.

14. The composite material composition as claimed in claim 13, wherein the composition is produced by incorporating a vapor grown carbon fiber having a bulk density of 0.01 to 0.1, while a breakage rate of the carbon fiber is controlled to 20% or less.

15. The composite material composition as claimed in claim 13, wherein the synthetic resin is a thermoplastic resin.

16. The composite material composition as claimed in claim 13, which exhibits a thermal conductivity of 1 W/mK or higher.

17. A method for producing a composite material composition characterized by comprising kneading a thermoplastic resin and a vapor grown carbon fiber having a fiber diameter of 50 to 200 nm, an aspect ratio of 40 to 1,000, a bulk density of 0.01 to 0.1 and a peak intensity ratio (I₀=I₁₃₆₀/I₁₅₈₀) of 0.1 to 1, wherein I1580 represents a peak height at 1,580 cm⁻¹ and I₁₃₆₀ represents a peak height at 1,360 cm⁻¹ in a Raman scattering spectrum, wherein the kneading is performed without applying strong shear force, so as to suppress breakage rate of the carbon fiber to 20% or less.

18. The method for producing a composite material composition as claimed in claim 17, wherein the vapor grown carbon fiber is incorporated into a composite material composition in an amount of 10 mass % to 70 mass % during kneading of the thermoplastic resin and the vapor grown carbon fiber.

19. The method for producing a composite material composition as claimed in claim 17, wherein the thermoplastic resin and the vapor grown carbon fiber are kneaded while breakage rate of the carbon fiber is suppressed to 20% or less, by melt-kneading using a pressure kneader and subsequent pelletizing using a single-screw extruder or a reciprocating-single-screw extruder.

20. A method for producing a composite material molded article, characterized by comprising molding a composite material composition produced by the method for producing a composite material composition as claimed in claim 17, at a mold temperature 20° C. to 40° C. higher than such an injection molding temperature that the time required for cooling the mold is five seconds and a non-defective production rate of 95% or higher is attained.

21. A precision-molding synthetic resin molded article, which employs a resin composition produced through a method for producing a precision-molding composite material composition as claimed in claim 17.

22. A container for electric and electronic parts, which employs a resin composition produced through a method for producing a precision-molding composite material composition as claimed in claim 17.

23. A sliding member composition produced by kneading a matrix synthetic resin and a vapor grown carbon fiber, wherein the vapor grown carbon fiber has a fiber diameter of 50 to 200 nm, an aspect ratio of 40 to 1,000, and a peak intensity ratio (I₀=I₁₃₆₀/I₁₅₈₀) of 0.1 to 1, wherein I₁₁₅₈₀ represents a peak height at 1,580 cm⁻¹ and I₁₁₃₆₀ represents a peak height at 1,360 cm⁻¹ in a Raman scattering spectrum, and the composition exhibits a heat deflection temperature of 160° C. or higher under heavy load, as determined in accordance with ASTM D 648.

24. The sliding member composition as claimed in claim 23, which contains the vapor grown carbon fiber in an amount of 10 mass % to 70 mass %.

25. The sliding member composition as claimed in claim 23, which exhibits a thermal conductivity of 1 W/mK or higher.

26. The sliding member composition as claimed in claim 23, which exhibits a flexural modulus of 4,000 MPa or more.

27. A method for producing a sliding member composition characterized by comprising kneading a thermoplastic resin and a vapor grown carbon fiber having a fiber diameter of 50 to 200 nm, an aspect ratio of 40 to 1,000, a bulk density of 0.01 to 0.1, and a peak intensity ratio (I₀=I₁₃₆₀/I₁₅₈₀) of 0.1 to 1, wherein I1580 represents a peak height at 1,580 cm⁻¹ and I₁₃₆₀ represents a peak height at 1,360 cm⁻¹ in a Raman scattering spectrum, wherein the kneading is performed without applying strong shear force so as to suppress breakage rate of the carbon fiber to 20% or less.

28. The method for producing a sliding member composition as claimed in claim 27, wherein the vapor grown carbon fiber is incorporated into a composite material composition in an amount of 10 mass % to 70 mass % during kneading of the thermoplastic resin and the vapor grown carbon fiber.

29. The method for producing a sliding member composition as claimed in claim 27, wherein the thermoplastic resin and the vapor grown carbon fiber are kneaded while breakage rate of the carbon fiber is suppressed to 20% or less, by melt-kneading using a pressure kneader and subsequent pelletizing using a single-screw extruder or a reciprocating-single-screw extruder.

30. The method for producing a molded sliding member, characterized by comprising molding a sliding member composition produced by the method for producing a sliding member composition as claimed in claim 27, at a mold temperature 20° C. to 40° C. higher than such an injection molding temperature that the time required for cooling the mold is five seconds and a non-defective production rate of 95% or higher is attained.

31. A sliding synthetic-resin molded article, which employs a resin composition produced by the method for producing a sliding member composition as claimed in claim 27.

32. A non-lubricant sliding member, which employs a resin composition produced by the method for producing a sliding member composition as claimed in claim 27.
